(19) United States
(12) Patent Application Publication
(10) Pub. No.: US 2008/0003957 A1
(43) Pub. Date: Jan. 3, 2008

(54) MESSAGE GENERATION WITH IDENTIFICATION GROUP INFORMATION

(75) Inventors: NORBERT SCHWAGMANN, Braunschweig (DE); HOLGER SCHMIDT, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/770,346

(22) Filed: Jun. 28, 2007

Related U.S. Application Data
(60) Provisional application No. 60/806,049, filed on Jun. 28, 2006.

(51) Int. Cl. H04B 1/02

(52) U.S. Cl. 455/91

(57) ABSTRACT

A message generating device configured to generate a message with the information indicating which identifications are part of an identification group, wherein the identifications are assigned a communications terminal, and wherein, if the communications terminal is registered in the communications network under an identification of the identification group, the communications terminal is also registered in the communications network under the other identifications of the identification group.

### CROSS-REFERENCE TO RELATED APPLICATION

This application claims priority to Provisional Patent Application Ser. No. 60/806,049, which was filed Jun. 28, 2006, and is incorporated herein by reference in its entirety.

### FIELD OF THE INVENTION

The invention relates to a message generating device, a communications system and a method for operating a communications system.

### BACKGROUND OF THE INVENTION

Within the scope of the 3^{rd} Generation Partnership Project (3GPP), a standard has been developed for what is referred to as the Internet Protocol Multimedia Subsystem (IMS) architecture.

An IMS, that is to say a communications network according to this IMS standard which has been developed by the 3GPP, makes it possible to provide a mobile terminal with various communications services on the basis of the Internet Protocol (IP).

Such communication services are, for example Voice-over-Internet protocol (VoIP), video telephony and conference communications services, for example telephone conferences.

According to IMS, the data transmission for the communications services is based on the Internet protocol. As a result it is possible to provide communications services by means of all packet-based communications systems, for example a wireless local area network (W-LAN), a GPRS (General Packet Radio Service) communications network and a UMTS (Universal Mobile Telecommunications System) communications network. In particular an IMS makes it possible to make a large number of communications services accessible to a wide user base.

The IMS can be considered to be an extension of the packet-oriented core network of the mobile radio communications system according to the 3GPP standard. The IMS is used to carry out the signaling for packet-switched communications services (which are also referred to as IP-based services or multimedia services). The IMS therefore provides basic functionalities for packet-switched communications services such as, for example, message routing, charging, quality of service and security functionalities. The signaling in the IMS is carried out according to the SIP (Session Initiation Protocol).

A user of an IMS can be assigned a plurality of public user identifications. If a user wishes to use a communications service by employing one of his public user identifications, he must be registered in the IMS for this public user identification.

### SUMMARY OF THE INVENTION

A message generating device is provided which is configured to generate a message for transmission to a communications terminal assigned a plurality of identifications under which the communications terminal can be registered in a communications network, wherein at least two identifications of the plurality of identifications are combined to form an identification group, and wherein, if the communications terminal is registered in the communications network under an identification of the identification group, the communications terminal is also registered in the communications network under the other identifications of the identification group. The message contains the information indicating which identifications of the plurality of identifications are part of the identification group.

### BRIEF DESCRIPTION OF THE FIGURES

FIG. 1 shows a message generating device according to an exemplary embodiment of the invention,

FIG. 2 shows a communications system according to an exemplary embodiment of the invention, and

FIG. 3 shows an identification structure according to an exemplary embodiment of the invention.

### DETAILED DESCRIPTION OF THE INVENTION

According to one exemplary embodiment of the invention, a message generating device is made available which generates a message for transmission to a communications terminal, wherein the communications terminal is assigned a plurality of identifications under which the communications terminal can be registered in a communications network, wherein at least two identifications of the plurality of identifications are combined to form an identification group, and wherein, if the communications terminal is registered in the communications network under an identification of the identification group, it is also registered in the communications network under the other identifications of the identification group. The message contains the information indicating which identifications of the plurality of identifications are part of the identification group.

In addition, according to further exemplary embodiments, a communications system and a method for operating a communication system are provided according to the message generating device described above.

According to one exemplary embodiment of the invention, a user-friendly way for registering and deregistering user identifications is provided in a communications network.

The embodiments of the invention which are described in relation to the message generating device apply appropriately also to the communications system and to the method for operating a communications system.

According to one exemplary embodiment of the invention, which identifications of the communications terminal belong to common identification groups is signaled to the communications terminal, wherein registration or also deregistration of the communications terminal is always carried out jointly for all identifications of an identification group.

In this way, the user is always aware of which of his identifications (or which identifications of his communications terminal) are combined to form identification groups, and it is possible to avoid a user being unintentionally registered or deregistered under identifications, which can occur if the user is not informed about which identifications are combined to form identification groups.

The user is thus made aware of the identifications under which he is implicitly registered or deregistered if he registers or deregisters himself at a specific identification.

An identification group can also be defined by the fact that if the communications terminal is deregistered from the communications network under an identification of the identification group, it is also deregistered from the communications network under the other identifications of the identification group.

The communications network is, for example, a signaling network. The communications network can, for example, be a signaling network for transmitting signaling data within the scope of packet-switched communications services, for example an IMS (Internet Protocol Multimedia Subsystem).

In one embodiment, the message is a confirmation message with a confirmation for registration of the communications terminal under an identification of the plurality of identifications in the communications network which has been requested by the communications terminal.

For example, the information indicating which identifications are part of the identification group is transmitted by means of an extension of the P-Associated URI message header in a 200 OK message according to SIP (Session Initiation Protocol) which is transmitted in response to a REGISTER message of the communications terminal.

In another embodiment, the message is an information message by means of which the identifications under which the communications terminal is currently registered in the communications network are signaled to the communications terminal. The message can be transmitted to the communications terminal within the scope of a registration state event package subscription, for example.

For example, the information indicating which identifications are part of the identification group is transmitted by means of an extension of a notification message which is sent in the SIP Event Package for registrations.

The message has, for example, a specification of at least one identification of the plurality of identifications, and for the at least one specified identification it has a specification which indicates that the at least one specified identification is part of the identification group.

In one embodiment, if the communications terminal is deregistered from the communications network under an identification of the identification group, it is also deregistered from the communications network under the other identifications of the identification group.

Exemplary embodiments of the invention are illustrated in the figures and will be explained in more detail in the text which follows.

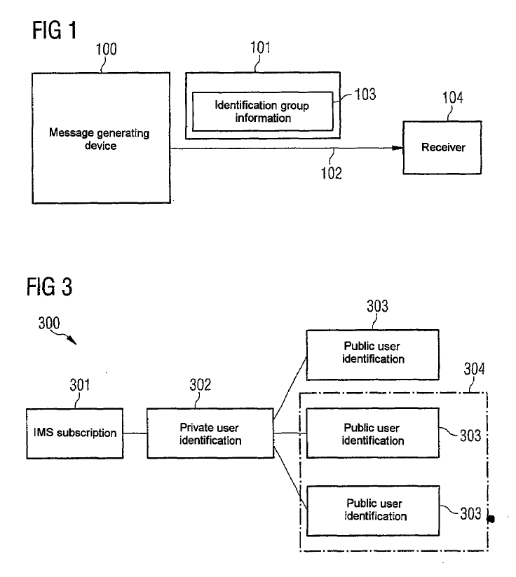

FIG. 1 shows a message generating device 100 according to an exemplary embodiment of the invention.

The message generating device 100 generates a message 101 which is transmitted to a receiver 104, as is illustrated by the arrow 102. The communications terminal is assigned a plurality of identifications under which the communications terminal can be registered in a communications network. A plurality of identifications of the plurality of identifications are combined to form an identification group, and if the communications terminal is registered in the communications network under an identification of the identification group, it is also registered in the communications network under the other identifications of the identification group. The message 101 contains the information 103 indicating which identifications of the plurality of identifications are part of the identification group.

In one embodiment, if the communications terminal is deregistered from the communications network under an identification of the identification group, it is also deregistered from the communications network under the other identifications of the identification group.

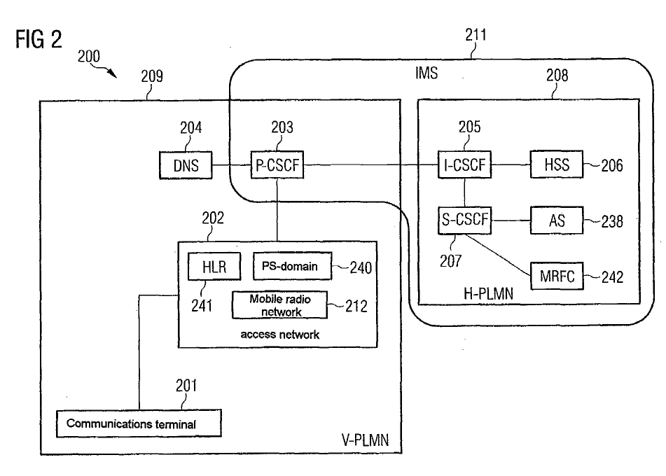

FIG. 2 shows a communications system 200 according to an exemplary embodiment of the invention.

The communications system 200 is embodied according to the UMTS architecture described by 3GPP, an integral component of which is an IMS 211. A communications terminal 201 is connected to the IMS 211 by means of an access network 202.

The access network 202 can be, for example, a mobile radio communications network according to the UMTS standard, i.e. a Universal Terrestrial Access Network which, by means of a packet-switched domain, permits the communications terminal to access the IMS 211, but in another embodiment it can also be an access network according to the GSM standard, for example a GSM Edge radio access network.

The access network 202 can also be a fixed line network. For example, the communication terminal 201 can have a device which permits access to the Internet, for example a DSL (Digital Subscriber Line). In this example, the communications terminal is connected to the IMS 211 by means of the Internet.

Depending on the configuration of the access network 202, the communications terminal 201 is, for example, a mobile phone or a computer with or without a mobile radio module.

In this exemplary embodiment, the access network 202 is a mobile radio communications system according to the UMTS communications standard.

A mobile radio network 212 of the access network 202 has the architecture of a UMTS radio network, which is also referred to as a UMTS terrestrial radio access network (UTRAN).

The access network 202 has a PS domain 240 which has the components SGSN (Serving GPRS Support Node) and GGSN (Gateway GPRS Support Node) and forms the interface for packet-switched communications links between the mobile radio network 212 and external packet-based data networks such as, for example, the Internet, and implements the access to the IMS 211.

Correspondingly, the PS domain 240 carries out all the functions which are necessary to ensure the transportation of packet-switched data. Furthermore, it permits the transportation of signaling messages to the IMS 211.

The access network 202 also has an HLR (Home Location Register) 241 which is a central database in which all the information on subscribers (users) which is necessary, inter alia, for connection setup and for carrying out communications services is stored.

By means of the access network 202, the communications terminal 201 is connected to a P-CSCF (CSCF: Call Session Control Function, P-CSCF: Proxy-CSCF) 203 of the IMS 211.

The P-CSCF 203 serves as a switching center and is connected to a DNS (Domain Name Service) server 204 and an I-CSCF (Interrogating CSCF) 205.

The I-CSCF 205 is connected to an HSS 206 (Home Subscriber Server) 206 and an S-CSCF (Serving CSCF) 207. The S-CSCF 207 is connected to a plurality of application servers (AS, application server), of which only one application server 238 is shown. The S-CSCF 207 is also connected to an MRFC (Media Resource Function Controller) 242.

The communications terminal 201, the access network 202, the P-CSCF 203 and the DNS 204 are parts of the visited network (V-PLMN) 209. The I-CSCF 205, the HSS 206, the S-CSCF 207 and the application server AS 238 are parts of the home communications network (H-PLMN) 208. The P-CSCF 203, I-CSCF 205, the HSS 206 and the S-CSCF 207 are part of the IMS (IP Multimedia Core Network Subsystem) 211.

By means of the communications terminal 201, a user can use the communications services of the IMS 211, for example can send an instant message to a further communications terminal which is connected to the communications system 200, or can conduct a conference with the users of other communications terminals which are connected to the communications system 200.

Before the user of the communications terminal 201 can use communications services by means of the IMS 211 (and for example can be reached by means of the IMS 211), it is necessary for the user to be registered in the IMS 211, to be more precise at an S-CSCS 207. The registration is not permanently valid but rather is valid only for a specific period. The user has to renew the registration before this period expires (re-registration), and otherwise the user is deregistered. However, the user can register himself again in the IMS 211 at any time after a deregistration.

It is possible, for example, to provide for the communications terminal 201 to carry out registration automatically when it is switched on.

A user (or the communications terminal which he is using) can be registered in the IMS 211 under one or more public user identifications. The assignment of public user identifications to the user of the communications terminal 201 is illustrated in FIG. 3.

FIG. 3 shows an identification structure 300 according to an exemplary embodiment of the invention.

The user of the communications terminal 201 has subscribed as a user of the IMS 211 and thus corresponds to an IMS subscription 301. The user is identified in a uniquely defined fashion as an IMS subscriber by means of a single, private user identification (Private User Identity, Private User ID) 302. If the communications terminal 201 is, for example, a mobile radio subscriber device according to UMTS, the private user identification 302 is stored on the UICC (Universal Integrated Circuit Card) of the mobile radio subscriber device and is used exclusively on a network-internal basis for authentication, i.e. neither the user of the communications terminal 201 nor any other party to the communication uses the private user identification 302, and the private user identification 302 cannot be seen either by the user of the communications terminal 201 or by any other communication partner of the user.

The private user identification 302 is assigned a plurality of public user identifications (Public User Identities, Public User IDs) 303. A public user identification (Public User ID) 303 is illustratively an address by which the user can be reached in the IMS 211. In this exemplary embodiment, the user of the communications terminal 201 is assigned, for example, the public user identifications

sip:peter@home1.de

tel:+49-89-4444@home2.de

sip:peter@work1.de

tel:+49-89-55555@work2.de.

A registration request from the communications terminal 201 refers only to a single public user identification 303. For example, by sending a registration request message to the IMS 211, the communications terminal 201 can request that the public user identification sip:peter@home1.de be registered in the IMS 211. The registration request message is structured, for example, as follows, according to the SIP format:

REGISTER sip:home1.de SIP/2.0
Via: SIP/2.0/UDP [5555::a:b:c:d]
From: <sip:peter@home1.de>; tag=pohja
To: <sip:peter@home1.de>
Contact: <sip: [5555::a:b:c:d] >; expires=3600

The effect of the registration of the public user identification sip:peter@home1.de in the IMS 211 is that for the next 3600 seconds (this period is specified by the character string “Expires=3600” on line 5) all communications request messages which are sent to the IMS 211 with the address sip:peter@home1.de are routed to the communications terminal 201.

In response to the registration request message described above, which, as shown in this exemplary embodiment, is configured as a REGISTER message according to SIP, the IMS 211 transmits a confirmation message to the communications terminal, in the form of a 200 OK message according to SIP in this exemplary embodiment. The confirmation message has a P-associated URI header in which all the public user identifications 303 assigned to the user of the communications terminal 201 are listed, with the public user identification 303 which is registered according to the registration request message appearing first. The confirmation message is correspondingly structured according to the SIP format as follows, for example:

SIP/2.0 200 OK
P-Associated-URI:<sip:peter@home1.de>, <sip:peter@work1.de>
<sip:+49-89-4444@home2.de; user=phone>,
<sip:+49-89-55555@home2.de;
user=phone>,

A plurality of public user identifications 303 are combined to form an identification group 304 which is also referred to as an implicit registration set. The significance of the identification group 304 is that as soon as a public user identification 303 of the identification group 304 is registered in the IMS 211 according to a registration request (which is referred to as an explicit registration), all the further public user identifications 303 from the identification group 304 are also registered in the IMS 211 (which is referred to as implicit registration). Analogously, in the case of an (explicit) deregistration of a public user identification 303 from the identification group 304, all the further public user identifications 303 of the identification group 304 are (implicitly) deregistered automatically.

In the text which follows it is assumed that the public user identifications sip:peter@home1.de and tel:+49-89-4444@home2.de are combined to form a first identification group and that the public user identifications sip:peter@work1.de and tel:+49-89-55555@work2.de are combined to form a second identification group.

Implicit registration sets are typically defined by the corresponding user at the start of the subscription or when new public user identifications 303 are added for the user. Implicit registration sets are typically not defined using the communications terminal 201 but rather, for example, by means of a WWW form. In particular, in this case information indicating which public user identifications are combined to form an identification group cannot be stored in the communications terminal (for example by means of an UICC).

According to the IMS standard there is provision that after its registration in the IMS 211 the communications terminal 201 is subscribed to a registration state event package. This subscription results in the communications terminal 201 being informed whenever there is any change in the registration status of the user of the communications terminal 201.

This information is transmitted in the form of an XML document. If, for example, registration of the user of the communications terminal 201 is carried out for the public user identification sip:peter@home1.de and sip:peter@work1.de, a corresponding information message is structured, for example, as follows according to the SIP format:

<registration aor: “sip:peter@home1.de” id=”al” state=”active”>
<contact id=”1” state=”active” event=”registered”>
<uri>sip:[5555::1:2:3:4]</uri>
</contact>
</registration>
<registration aor:”tel+49-89-4444@home2.de” id=”a2” state=”active”>
<contact id=”2” state=”active” event=”created”>
<uri>sip:[5555::1:2:3:4]</uri>
</contact>
</registration>
<registration aor:”sip:peter@work1.de” id=”a3” state=”active”>
<contact id=”3” state=”active” event=”registered”>
<uri>sip:[5555::1:2:3:4]</uri>
</contact>
</registration>
<registration aor:”tel+49-89-55555@work2.de” id=”a4” state=”active”>
<contact id=”4” state=”active” event=”created”>
<uri>sip:[5555::1:2:3:4]</uri>
</contact>
</registration>

Each <registration> element which starts with the character string <registration> and ends with the character string </registration> respectively specifies the registration status for a public user identification. Since it is assumed that the user of the communications terminal 201 has requested a registration under the public user identification sip:peter@home1.de, the status here is “active” which is specified by the character string state=“active” (see line 1 of the information message). The character string aor stands for “Address of Record”.

The <contact> element specifies, by means of the character string event=“registered” (see line 2), that the public user identification has been registered by means of an explicit registration. The <uri> element (see line 3) specifies the IP address of the communications terminal 201.

Since the public user identification sip:peter@home1.de and the public user identification tel:+49-89-4444@home2.de form the second identification group, during the explicit registration of the public user identification sip:peter@home1.de the public user identification tel:+49-89-4444@home2.de has also been (implicitly) registered automatically. The registration of the public user identification tel:+49-89-4444@home2.de is specified by the character string state=“active” (see line 6) in the corresponding <registration> element. The fact that it is an implicit registration is indicated by the character string event=“created” (see line 7), which is part of a <contact> element. Since both the public user identifications are identifications of the communications terminal 201, the IP address which is contained in the <contact> element (see the <uri> element on line 8) is the same.

Analogously, the registration status of the public user identification sip:peter@work1.de and of the public user identification tel:+49-89-55555@work2.de, which are combined to form the second identification group, is specified in the information message. The two public user identifications are registered, which is indicated by the character strings state=“active” on line 12 and on line 16. The public user identification sip:peter@work1.de has been explicitly registered, which is indicated by the character string event=“registered” on line 12. The public user identification tel:+49-89-55555@work2.de has been implicitly registered, which is indicated by the character string event=“created” on line 17. The same IP address is specified again in each of the corresponding <uri> elements.

By means of the confirmation message, which the IMS 211 transmits to the communications terminal 201 in response to a registration request of the communications terminal 201, and by means of an information message which is transmitted to the communications terminal 201 within the scope of the registration state event package subscription, information about which public user identifications of the user of the communications terminal 201 are combined to form an identification group (Implicit Registration Set) can be transmitted to the communications terminal 201.

For example, in the confirmation message which is transmitted to the communications terminal in response to a registration request, the public user identifications which are listed in the P-Associated URI header can each be provided with an identification group specifier (Implicit Registration Set ID; irs-id) which specifies the identification group to which the respective public user identification belongs. For example, the confirmation message is structured as follows according to the SIP format (the differences from the confirmation message described above are given in bold):

SIP/2.0 200 OK
P-Associated-URI: <sip:peter@home1.de; irs-id=1>,
<sip:peter@work1.de; irs-id=2>, <sip:+49-89-4444@home2.de;
user=phone; irs-id=1>, <sip:+49-89-55555@home2.de; user=phone;
irs-id=2>

By means of the identification group specifiers, the communications terminal 201 can determine unambiguously which of the public user identifications are combined to form a common identification group.

Analogously, in an information message which is transmitted to the communications terminal 201 within the scope of the registration state event package subscription of the communications terminal 201 it is possible to provide each of the public user identifications with an identification group specifier. An information message is correspondingly structured, for example, as follows according to the SIP format:

<registration aor: “sip:peter@home1.de” id=”al” state=”active” irs-id=1>
<contact id=”1” state=”active” event=”registered”>
<uri>sip:[5555::1:2:3:4]</uri>
</contact>
</registration>
<registration aor:”tel+49-89-4444@home2.de” id=”a2” state=”active”
irs-id=1>
<contact id=”2” state=”active” event=”created”>
<uri>sip:[5555::1:2:3:4]</uri>
</contact>
</registration>
<registration aor:”sip:peter@work1.de” id=”a3” state=”active” irs-id=2>
<contact id=”3” state=”active” event=”registered”>
<uri>sip:[5555::1:2:3:4]</uri>
</contact>
</registration>
<registration aor:”tel+49-89-55555@work2.de” id=”a4” state=”active”
irs-id=2>
<contact id=”4” state=”active” event=”created”>
<uri>sip:[5555::1:2:3:4]</uri>
</contact>
</registration>

The changes compared to the information message described above are also given in bold. In this case also, the communications terminal 201 can relate any public user identifications to an identification group, i.e. it can determine which of the public user identifications are combined to form an identification group.

The entity which transmits to the communications terminal 201 the confirmation message or the information message with the information indicating which public user identifications are combined to form an identification group is, for example, the S-CSCF 207.

In another embodiment, the confirmation message or the information message is not used to transmit the information to the communications terminal indicating which public user identifications are combined to form an identification group but rather an accumulative message which is provided specially for this purpose and contains this information is transmitted to the communications terminal.

In summary, in one embodiment, a message generating device is provided which generates a message for transmission to a communications terminal, wherein the communications terminal is assigned a plurality of identifications under which the communications terminal can be registered in a communications network, wherein at least two identifications of the plurality of identifications are combined to form an identification group, and wherein, if the communications terminal is registered in the communications network under an identification of the identification group, it is also registered in the communications network under the other identifications of the identification group. The message contains the information indicating which identifications of the plurality of identifications are part of the identification group.

In another embodiment, a message generating device is provided which generates a message for transmission to a communications terminal, wherein the communications terminal is assigned a plurality of identifications under which the communications terminal can be registered in an IMS, wherein at least two identifications of the plurality of identifications are combined to form an identification group, and wherein, if the communications terminal is registered in the IMS under an identification of the identification group, it is also registered in the IMS under the other identifications of the identification group. The message contains the information indicating which identifications of the plurality of identifications are part of the identification group.

In another embodiment, a registration server is provided, which receives a registration request from a communications terminal, wherein the communications terminal is assigned a plurality of identifications under which the communications terminal can be registered at the registration server, wherein at least two identifications of the plurality of identifications are combined to form an identification group, and wherein, if the communications terminal is registered at the registration server under an identification of the identification group, it is also registered at the registration server under the other identifications of the identification group. The registration server generates a message with the information indicating which identifications of the plurality of identifications are part of the identification group.

In a further embodiment, a message generating device is provided which generates a message for transmission to a communications terminal, wherein the communications terminal is assigned a plurality of identifications under which the communications terminal can be registered in a communications network, wherein at least two identifications of the plurality of identifications are combined to form an identification group, and wherein, if the communications terminal is deregistered from the communications network under an identification of the identification group, it is also deregistered from the communications network under the other identifications of the identification group. The message contains the information indicating which identifications of the plurality of identifications are part of the identification group.

What is claimed is:

1. A message generating device configured to generate a message for transmission to a communications terminal assigned a plurality of identifications under which the communications terminal can be registered in a communications network,
wherein at least two identifications of the plurality of identifications are combined to form an identification group, and wherein, if the communications terminal is registered in the communications network under an identification of the identification group, the communications terminal is also registered in the communications network under the other identifications of the identification group, and
wherein the message contains the information indicating which identifications of the plurality of identifications are part of the identification group.

2. The message generating device as claimed in claim 1, wherein the communications network is a signaling network.

3. The message generating device as claimed in claim 1, wherein the communications network is a signaling network for transmitting signaling data within the scope of packet-switched communications services.

4. The message generating device as claimed in claim 1, wherein the communications network is an IMS.

5. The message generating device as claimed in claim 1, wherein the message is a confirmation message with a confirmation for registration of the communications terminal under an identification of the plurality of identifications in the communications network which has been requested by the communications terminal.

6. The message generating device as claimed in claim 1, wherein the message is an information message by means of which the identifications under which the communications terminal is currently registered in the communications network are signaled to the communications terminal.

7. The message generating device as claimed in claim 6, wherein the message is transmitted to the communications terminal within the scope of a registration state event package subscription.

8. The message generating device as claimed in claim 1, wherein the message has a specification of at least one identification of the plurality of identifications, and for the at least one specified identification has a specification which indicates that the at least one specified identification is part of the identification group.

9. The message generating device as claimed in claim 1, wherein the communication terminal, if the communications terminal is deregistered from the communications network under an identification of the identification group, also is deregistered from the communications network under the other identifications of the identification group.

10. A communications system comprising:
a communications network;
a communications terminal being assigned a plurality of identifications under which the communications terminal can be registered in the communications network, wherein at least two identifications of the plurality of identifications are combined to form an identification group, and wherein, if the communications terminal is registered in the communications network under an identification of the identification group, the communications terminal is also registered in the communications network for the other identifications of the identification group;
a message generating device configured to generate a message containing the information indicating which identifications of the plurality of identifications are part of the identification group; and
a signaling device configured to transmit the message to the communications terminal.

11. A method for operating a communications system having a communications network and a communications terminal assigned a plurality of identifications under which the communications terminal can be registered in the communications network, wherein at least two identifications of the plurality of identifications are combined to form an identification group, and wherein, if the communications terminal is registered in the communications network under an identification of the identification group, the communications terminal is also registered in the communications network for the other identifications of the identification group, the method comprising:
generating a message containing the information indicating which identifications of the plurality of identifications are part of the identification group; and
transmitting the message to the communications terminal.

12. A message generating device configured to generate a message for transmission to a communications terminal assigned a plurality of identifications under which the communications terminal can be registered in an IMS,
wherein at least two identifications of the plurality of identifications are combined to form an identification group, and wherein, if the communications terminal is registered in the IMS under an identification of the identification group, the communications terminal is also registered in the IMS under the other identifications of the identification group, and
wherein the message contains the information indicating which identifications of the plurality of identifications are part of the identification group.

13. A registration server configured to receive a registration request from a communications terminal assigned a plurality of identifications under which the communications terminal can be registered at the registration server,
wherein at least two identifications of the plurality of identifications are combined to form an identification group, and
wherein, if the communications terminal is registered at the registration server under an identification of the identification group, the communications terminal is also registered at the registration server under the other identifications of the identification group, and the registration server configured to generate a message with the information indicating which identifications of the plurality of identifications are part of the identification group.

14. A message generating device configured to generate a message for transmission to a communications terminal assigned a plurality of identifications under which the communications terminal can be registered in a communications network,
wherein at least two identifications of the plurality of identifications are combined to form an identification group, and wherein, if the communications terminal is deregistered from the communications network under an identification of the identification group, the communications terminal is also deregistered from the communications network under the other identifications of the identification group, and
wherein the message contains the information indicating which identifications of the plurality of identifications are part of the identification group.

15. A communications system comprising:
a communications network;
a communications terminal being assigned a plurality of identifications under which the communications terminal can be registered in the communications network, wherein at least two identifications of the plurality of identifications are combined to form an identification group, and wherein, if the communications terminal is registered in the communications network under an identification of the identification group, the communications terminal is also registered in the communications network for the other identifications of the identification group;
a message generating means for generating a message containing the information indicating which identifications of the plurality of identifications are part of the identification group; and
a signaling means for transmitting the message to the communications terminal.
